(19) United States
(12) Patent Application Publication
(10) Pub. No.: US 2010/0266783 A1
(43) Pub. Date: Oct. 21, 2010

(54) METHOD OF COATING A SUBSTRATE

(75) Inventors: Theodore A. Krengel, Flossmoor, IL (US); Curt Brown, Homewood, IL (US)

Correspondence Address: HOWARD & HOWARD ATTORNEYS PLLC, 450 West Fourth Street, Royal Oak, MI, 48067, US

(73) Assignee: HOT DIP SOLUTIONS, LLC, Flossmoor, IL (US)

(21) Appl. No.: 12/758,098

(22) Filed: Apr. 12, 2010

Related U.S. Application Data
(60) Provisional application No. 61/169,330, filed on Apr. 15, 2009.

(51) Int. Cl. B05D 3/02

(52) U.S. Cl. 427/543

(57) ABSTRACT

A method of coating a metal substrate with a protective metal coating by melting the coating, heating the surface only of the substrate with a high frequency induction heater to the melting temperature of the coating or greater and substantially immediately applying the molten metal coating to the heated substrate prior to penetrate of the heat through the substrate.

### RELATED APPLICATION

This application claims priority to U.S. Provisional Patent Application Ser. No. 61/169,330 filed Apr. 15, 2009.

### FIELD OF THE INVENTION

This invention relates to a method of coating a metal substrate with a protective metal coating having a melting temperature which is substantially less than the melting temperature of the substrate. For example only, the substrate may be a steel or a ferrous metal tube, pipe, solid material, such as bar, beam, channel, plate or strip of any width or length and the protective metal coating may be zinc, aluminum or various alloys of zinc and aluminum or other protective coating materials that adhere to an inductive substrate material, such as tin, silver, or copper. The method of this invention may be a continuous in-line process or the substrates may be individually coated in a batch process.

### BACKGROUND AND SUMMARY OF THE INVENTION

In strip, bar and tube, in-line continuous coating systems, material speeds as high as 1000 feet per minute have been achieved successfully. In real time, the material will have traveled almost 17 feet in 1 second. In the case of the tube coating, the length of time the steel substrate is in contact with the zinc after full material heating is about 0.1 second, and into a water quench in less than 2 seconds.

The method of coating of this invention uses an electrical induction method of heating the substrate, but rather than use 3000 hertz or less—as is common in the industry, the method of this invention uses a high frequency induction heater at frequencies such as 50,000 hertz or higher (or lower where applicable, provided only the surface of the substrate is induction heated). The ultimate goal is to “surface heat” only the metal substrate such as steel, allowing the surface heat to be used in the molten coating metal, and then allowing for the conductivity of the remaining substrate to sync or soak the heat away from the molten coating on the surface of the substrate. With the heat syncing of the surface of the substrate, the protective metal coating cools quickly allowing for the potential for thicker coatings than is currently available with the present coating methods.

The “surface heat” temperature required is a relative value dependent upon the molten coating material to be used. For example, the melting temperature of zinc is 787° F., usually applied at 850° F., but in the method of this invention, the surface temperature may need to be as low as the melting temperature of the protective metal coating or as high as up to 1000° F. or more. In the case of Aluminum as the protective metal coating, the melting temperature is 1220° F., usually applied at 1350° F., but in the method of this invention, the aluminum coating may need to be applied at higher temperatures—up to 1500° F. The type of coating material can have a melting temperature as low as 449° F. for Tin, or as high as 1983° F. for Copper. Alloy versions of combination metals will have various melting temperatures as well. In short, it is believed that the surface temperature needed should fall within 300° F. of the melting temperature of the molten protective metal coating material to be applied. As known to those skilled in the art, many alloys of coating materials, such as alloys of zinc and aluminum, have lower melting temperatures than either of the metals alone. For example, certain alloys of zinc, aluminum and magnesium have melting temperatures of 640° F. or less.

In an induction heating process, the frequency of the induction determines the “depth of penetration” of the induction current through the substrate. The lower the frequency, the deeper the inductive heat penetration—resulting in a more complete heating of the substrate. As the frequency increases, the heating depth of penetration decreases. For example, a 3000 Hertz frequency in mild steel has a depth of penetration of roughly 0.042″. A 50,000 hertz frequency in the same steel would result in a depth of penetration of roughly 0.007″. Higher frequencies such as 200,000 hertz would have a depth of penetration of 0.005 inches. Although the method of coating a metallic substrate of this invention may be used for coating various substrates, the most common substrate for this application is a ferrous metal substrate, particularly steel and the method of this invention will therefore be described as a method of coating a steel substrate, but the method of this invention is not limited to coating a steel substrate.

If the goal of the conventional induction heating is to completely heat the steel substrate to a set temperature thru-out, as in the current coating methods, in most cases the lower frequency performs heating of the substrate much more efficiently. As the thickness of the steel substrate increases, the lower the frequency, the better the complete heating. Even then, the allowance of time for the heat to penetrate the steel via conductive heat is required. From a costing standpoint, fully heating the steel substrate with the low (3000 hertz or less) frequencies would be recommended.

The second part of the goal of this invention is twofold; first, to increase the potential thickness of the protective metal coating as by heating and cooling the opposed sides of the substrate (e.g. the interior and exterior of a tube), thus freezing the protective meal coating faster, permitting a thicker coating. The second goal is there are several alloys where the quick freezing of protective metal alloy creates a eutectic version of the alloy which has superior properties.

In the method of this invention, utilizing the minimum depth of penetration caused by the higher induction frequencies, allows for the steel substrate surface, for example, to be heated, and then substantially immediately (preferably within about 0.1 or 0.2 seconds), the steel substrate would be either immersed into the molten protective metal coating or otherwise applied (sprayed, “rolled on”, etc.). The distance traveled in the fractional seconds of time will be dependent on the mill speed, so distances and time frames will be relative. As soon as the steel leaves the molten coating metal, the coating thickness is adjusted by one of several available means, such as, but not limited to, “gas knives” or electrical controls if necessary.

As soon as the material leaves the molten metal, the “unheated” interior portion of the substrate will begin heat syncing the residual heat from the heated surface, providing a relatively rapid heat loss at the coated surface area until the steel substrate is “equal in temperature” thru-out. At this point of the process, standard means of cooling can be used such as water, steam, air, most any inert or de-oxidizing gas, or time to bring the temperature of the coated substrate down to allowable temperatures.

In terms of “applicable frequency”, it is believed that the value will vary dependant on the wall thickness of the material to be coated and the speed of the material being coated. In example, product “A” with a wall thickness of 0.060 inches traveling at 300 feet per minute, a 50,000 hertz value or higher would be recommended. Product “B” with a wall thickness of 0.250″ traveling at 150 feet per minute, a 3000 hertz frequency may be required. Product “C” with a thickness of 0.030″ traveling at 800 feet per minute may need a frequency of 200,000 hertz. In one preferred embodiment, the metal substrate is heated with an induction heater at a frequency of 10,000 hertz or greater.

Included in this concept, is the ability to control the liquid coating material temperature just before the steel substrate contacts the liquid. It is important to any plating or coating process to complete clean the surface to be coated and remove oxides, debris or soil and water. In the process of this invention, the surface to be coated may be cleaned by an acid bath or wheel abrading to remove oxides, then washed with an alkali and dried or any conventional cleaning process.

The primary advantages of the method of this invention are as follows:
The energy requirements to heat just the surface of the steel substrate are a relative constant regardless of wall thickness of the substrate. As the wall thickness increases, the heating costs do not. With the existing full heating process, the cost of heating goes up linearly as the wall thickness increases assuming speed stays the same. Thus, the method of this invention is particularly advantageous with thicker-walled pipe and plates. This will discussed further below.
The rapid cooling of the substrate after leaving the molten metal bath will eliminate the need for the additional alloys of the newer coating alloys, the time needed to cool—thus either allowing existing coating systems to either speed up the operation—increasing productivity, decrease the tower height or for newer installations to have smaller cooling towers.
The rapid cooling of the coated part resulting from the fact that only the surface is heated will also decrease operational costs because of the reduced energy needed to cool the material down.
Due to the quick freeze of the coating, improved surface thickness variation may be achieved.
Better overall heat control of both the substrate and the coating metal bath can be achieved versus standard gas fired type of heating systems.
The higher the frequency, the quieter the induction unit. At 50,000 hertz for example is almost impossible to hear.
Wall thickness in standard coating systems can have significant variation that would normally affect the coating process. Wall thickness variation will not be affected with our process.
The method of this invention can vary the coating process to include coating on one side, both sides, or differential coatings on opposed sides.
With tubular coating systems, the elevated temperatures of the steel substrate requires specialized paints that can handle the extreme temperatures. With the process of this invention, the ID temperature will be reduced opening the opportunity for alternative—better and less costly paints.
Removal of the excess coating in atmosphere will reduce dross and oxides significantly.

Process Example: Theoretical calculations were made for a steel tube running on a continuous galvanizing line (A “Krengel Flo-Coat” line). Using the real time induction heating software, it was determined how fast a steel substrate would heat, and how fast it would begin to “heat sync” or “soak” internally after starting the heating process.

The method of this invention also significantly reduces the energy cost; not only because the energy required to heat only the surface of the substrate is reduced, but also because the molten protective metal coating with the method of this invention is applied at near the freezing temperature of the coating.

Using 3 test products and changing only the wall thickness to determine power requirements and temperature changes the following was determined.

Running a 3.00 inches diameter tube at 300 feet per minute, the amount of travel in 1 second is 60″. 1/10^{th} of a second would therefore be 6 inches.

With a 0.063 inches wall thickness, the surface would be heat to 850° F. in less than 0.1 seconds with an ID temperature of 351° F. 0.1 seconds later, the surface temperature would drop about 50° F. In another 0.1 seconds, the temperature will have dropped an additional 250° F. (NOTE: This computer model does not take into account the ramifications of the molten metal adding to the total heating (or cooling) process. This will be determined through actual testing. In roughly 0.25 seconds from the start of the heating process, the steel substrate will have “synced” at roughly 530° F., at which point conventional cooling methods will need to be used. At 50,000 hertz, the power requirement would be 650 Kw. Using standard 3000 hertz induction heating, the power requirement would be 1000 Kw. Economically, the electrical use requirements would be 65% for the higher frequency versus the lower frequency.

With a 0.100 inch wall thickness, the surface would again heat to 850° F. in less than 0.1 seconds with an ID temperature of 142° F.; 0.1 seconds later, the surface temperature would still only drop about 50° F. In another 0.1 seconds, the temperature will have dropped an additional 380° F. (NOTE: This computer model does not take into account the ramifications of the molten metal adding to the total heating or cooling process. This will be determined through actual testing). In roughly 0.3 seconds from the start of the heating process, the steel substrate will have “synced” at roughly 370° F., at which point conventional cooling methods will need to be used. At 50,000 hertz, the power requirement would be 714 Kw. Using standard 3000 hertz induction heating, the power requirement would be 1824 Kw. Economically, the electrical use requirements would be only 39% for the higher frequency versus the lower frequency.

With a 0.120 inch wall thickness, the power increase using 50,000 hertz would be only 6 kw higher at 720 Kw, while the conventional 3000 hertz process would need 2244 Kw. Economically, the electrical use requirements would be 32% for the higher frequency versus the lower frequency.

Briefly, the method of this invention includes melting the protective metal coating and heating the surface only of the substrate with a high frequency induction heater to a temperature equal to or preferably greater than the melting temperature of the protective metal coating. The method then includes substantially immediately applying the molten protective metal coating to the heated surface of the substrate prior to penetration of the heat through the substrate and then freezing the protective metal coating on the substrate. The method of this invention may be used to coat both sides of a metal plate, for example, by simultaneously heating the surface of both sides of the plate and applying molten protective metal coating to both sides prior to penetration of the heat through the plate by immersing the plate in molten protective metal coating, for example. In one preferred embodiment, the molten protective metal coating is applied within 0.3 seconds following heating or 0.1 seconds depending upon the factor stated above.

In the disclosed embodiment, the surface of the metal substrate is heated with an induction heater at a frequency of 10,000 hertz or greater. The protective metal coating may be applied to the heated surface of the metal substrate prior to fifty percent penetration of the heat through the substrate or prior to thirty percent penetration. As stated above, the metal substrate may be a ferrous metal substrate, such as steel and the protective metal coating may include zinc, aluminum or alloys thereof. As will be understood by those skilled in this art, various modifications may be made to the following disclosed embodiment of this invention within the purview of the appended claims. By way of example only, the method of this invention is equally application to coating solid bars and sheet metals.

### BRIEF DESCRIPTION OF THE DRAWING

The drawing and following description of a preferred embodiment illustrates the method of this invention coating a tube, piper or strip, such as a horizontal tube, wire, narrow strip, or similar product applications. The end product can be any size or shape as long as it can be run in a continuous line. The concept will easily work for vertical or any angle situations just as well, and in fact, for products such as wide steel strip would be preferred.

FIG. 1 is a side view, partially cross-sectioned of a pipe or tube being coated by the method of this invention.

### DESCRIPTION OF A PREFERRED EMBODIMENT

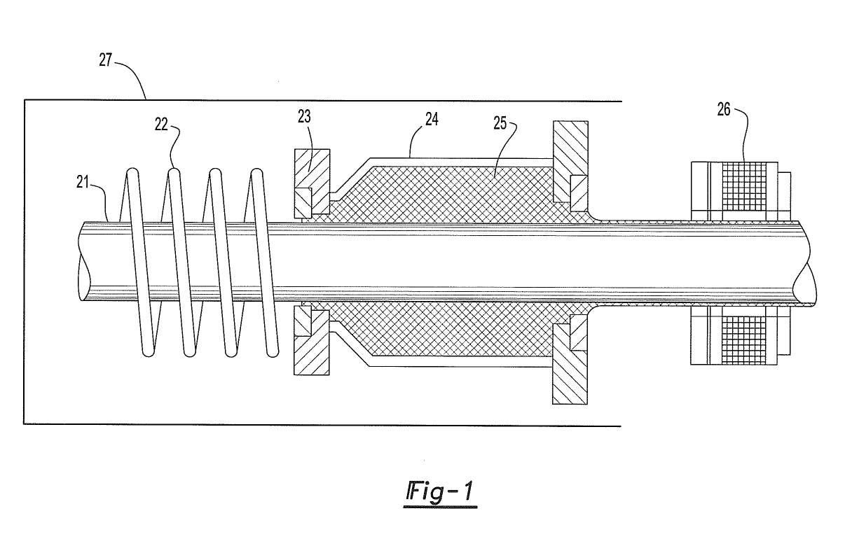

FIG. 1 represents the “tube or pipe” version of the method of this invention, but the disclosed method can be used for wire, rod, narrow strip, or other materials or substrate 21 to be coated in line or batch, referred to herein as the material or substrate. The method illustrated is only one of many potential ways the process can be performed. Again, the substrate to be coated may be vertical, horizontal or any other angle. In the disclosed embodiment of the method of this invention, the substrate is substrate 21 is moving. The material or substrate 21 to be coated is moving in FIG. 1 from right to left. The protective metal coating material to be applied, e.g.: zinc, aluminum, their alloys used in coating applications, including other metals as described above is to be referred to as “protective coating material” 25.

For example, a 3.00 inch Diameter Tube×0.0625″ Wall Thickness @ 300 Feet/Minute. Temperatures and time values are computer-generated estimates. Estimates do not consider any additional heat the coating material 25 generates at the surface when in contact with the substrate 21.

The cleaned, prepared material 21 to be coated travels into an enclosure 27. The substrate material 21 immediately enters into the coating chamber 24. It is also important in this process to completely fill the coating chamber 24 with molten protective metal coating material and maintain the coating chamber 24 completely full of molten metal coating. The purpose of the enclosure 27 is to enclose the substrate during heating and coating to avoid oxidation. The enclosure preferably has a non-oxidizing atmosphere, such as nitrogen or a reducing agent, such as hydrogen. It is believed, however, that a non-oxidizing atmosphere may not be required for all applications. The collars 23 at the entry and exit of the enclosure may be required to contain the non-oxidizing gas in the enclosure 27.

The coating chamber 24 may be made of a non-electric/high temperature material capable of coming into contact with the coating material 25 without problems. There are many types of refractoriness that are capable of being used. In the disclosed embodiment, the High Frequency (HF) work coil 22 surrounds the coating chamber at the entry end to heat the substrate material 23 to the necessary alloy temperature needed. As will be understood by those skilled in this art, where the method of this invention is used to surface heat a plate or strip, the induction coil may not be able to surround the plate or strip. Instead, a coil which only heats one side of the plate may be used. For example, a generally sinusoidal-shaped HF coil may be used adjacent one side of the plate may be used. A roller opposite the induction coil may also be useful to oppose the force of the flux of the induction heater. It is also possible to cool the opposite side of the plate to substantially immediately freeze the coating. The necessary alloy temperature can vary significantly from metal to metal alloy. Higher or lower substrate surface temperature may vary as well. For the purpose of this disclosure, the term alloy temperature needed or required temperature means the temperature required for heating the surface of the substrate to at or above the melting temperature of the protective metal coating as disclosed herein. The coupling gap is critical to the efficiency of the HF induction power, so the coating chamber 27 area between the tube 21 and the coil 22 will be relatively close. The HF work coil 22 integral with the coating chamber 24 may or may not be required for all applications, especially where the enclosure chamber 27 is filled with a non-oxidizing atmosphere. Further, the enclosure 27 may not be required if a non-oxidizing gas is pumped into the entry collar 23. There may, or may not, be a substrate material 21 stabilizing roll or fixture to assure the coupling of the HF work coil 22 to the material 21 stays constant.

As the substrate material 21 leaves the high frequency (HF) work coil 22 area, the coating chamber 24 is sized to allow free flowing molten coating metal 25 to surround the substrate material 21 being coated. The surface temperature of the material 21 as it leaves the HF work coil is of sufficient temperature as to allow for alloying to the coating material 25, but because the surface temperature will decrease extremely quickly, the distance from the HF coil to the coating material 25 is important. The length of the coating chamber 24 will be whatever length is necessary for the alloying to take place, but a longer length will not hurt the process. The application of the coating material 25 is not limited to a system as shown above. it is also important with the method of coating of this invention to control the temperature of the molten protective metal coating. The disclosed apparatus should include a temperature control which maintains the temperature of the molten metal coating preferably within plus or minus one percent. The protective metal coating can be also be sprayed, rolled, or applied in one of various ways.

One important element for the method of this invention is the issue of time and temperature, getting the material 21 to a necessary surface temperature with a “high enough” frequency, and having the material 21 come into contact with the molten coating material 25 as quickly as possible before losing the surface heat through conductivity into the body of the substrate material 21.

As the now coated substrate material leaves the coating chamber 24, an excess coating “wiping system” such as an air ring, magnetic lines of flux, or any other type of system 26 removes excess coating material 25 leaving a controlled coating thickness on the material 21. It is preferable that whatever wiping system is used, it is done within the controlled atmosphere, but this is not necessary because once the coating material 25 is alloyed to the steel substrate, the need for a controlled atmosphere is gone. That said, as long as the wiping system is in atmosphere, the amount of metal oxide generated is minimized.

As stated above, one advantage of the method of this invention is that the surface of the substrate opposite the induction heated surface may be painted with a coating, such as a water borne paint, Teflon or the like, which would burn or char in a conventional induction heating process where the surface is heated with a conventional low frequency induction heater. For example only, the inner surface of a steel pipe may first be coated or painted with a Teflon coating having a relatively low char temperature and the outer surface of the pipe may then be heated with a high frequency induction heater and coated with a molten zinc, aluminum or their alloys, as described above, without adversely affecting the Teflon coating on the inner surface of the pipe. In a conventional low frequency induction heating process, the low frequency induction heat would soak through the pipe and destroy the Teflon coating on the inner surface of the pipe.

Included in this concept, is the ability to control the liquid coating material 25 temperatures just before the steel substrate contacts the liquid—as it is pumped into the chamber 24.

As will be understood from the above description of the method of coating a metal substrate with an adherent protective metal coating of this invention, an important element of the process is the issue of time and temperature. Heating the surface of the metal substrate to a necessary surface temperature with a high frequency induction heater and substantially immediately applying the molten protective metal before the heat “soaks” through the substrate is very important to achieve the advantage of this invention. It is also important to control the temperature of the molten protective coating just before applying the coating to the heated substrate.

Having described the method of this invention, it is now claimed as follows:

1. A method of coating a metal substrate with an adherent protective metal coating having a melting temperature substantially less than the melting temperature of the metal substrate, comprising the following steps:
melting the protective metal coating;
heating the surface only of the metal substrate with a high frequency induction heater to a temperature equal to or greater than the melting temperature of the protective metal coating; and
substantially immediately applying the molten protective metal coating over the heated surface of the substrate prior to penetration of the heat through the substrate.

2. The method of claim 1, wherein the surface of the metal substrate is heated with an induction heater at a frequency of 10,000 Hertz or greater.

3. The method as defined in claim 1, wherein the method includes applying the molten protective metal coating on the substrate prior to fifty percent penetration of the heat through the substrate.

4. The method as defined in claim 1, wherein the method includes applying the molten protective metal coating on the substrate prior to thirty percent penetration of the heat through the substrate.

5. The method as defined in claim 1, wherein method includes heating the surface only of a ferrous metal substrate.

6. The method as defined in claim 1, wherein the method includes melting a protective metal coating which includes zinc.

7. The method as defined in claim 1, wherein the method includes applying molten protective metal coating over the heated surface of the substrate within 0.2 seconds following heating of the substrate.

8. The method as defined in claim 1, wherein the method includes applying molten protective metal coating over the heated surface of the substrate within 0.1 seconds following heating of the substrate.

9. The method as defined in claim 1, wherein the method includes substantially simultaneously surface heating opposed sides of the metal substrate with a high frequency induction heater and then substantially immediately applying the molten metal protective metal coating to both heated surfaces.

10. The method as defined in claim 1 wherein the surface of the substrate opposite the induction heated surface is first coating with a paint.

11. The method as defined in claim 1, wherein the temperature of the molten protective metal coating is controlled to within plus or minus one percent.

12. The method as defined in claim 1, wherein the method includes induction heating the metal substrate in an enclosed area and flooding the enclosed area with a non-oxidizing gas.

13. The method as defined in claim 1, wherein the method includes induction heating one surface of the metal substrate while cooling an opposed surface.

14. The method as defined in claim 1, wherein said method includes induction heating and coating one surface of the substrate, then induction heating and coating an opposite surface.

15. A method of coating a metal substrate comprising the following steps:
applying a paint to one surface of the substrate having a low burning temperature;
heating the opposite surface of the substrate with a high frequency induction heater to a temperature equal to or greater than the melting temperature of a protective metal coating; and
substantially immediately applying a protective metal coating to the induction heated surface prior to penetration of the heat to the painted surface of the substrate.
